(19) United States
(12) Patent Application Publication
(10) Pub. No.: US 2022/0106484 A1
(43) Pub. Date: Apr. 7, 2022

(54) Continuous Production Device and Method for Silane-Modified Sealing Material

(71) Applicant: Guangzhou Baiyun Chemical Industry Co., Ltd., Guangdong (CN)

(72) Inventors: Fei Long, Guangdong (CN); Jinbo Jiang, Guangdong (CN); Xueqing Hu, Guangdong (CN); Wenhao Chen, Guangdong (CN); Xiaohua Shi, Guangzhou (CN); Hengchao Huang, Guangdong (CN); Junbing Zhang, Guangdong (CN); Jianjin Lin, Guangdong (CN); Xiangnan Li, Guangdong (CN); Xu Yu, Guangdong (CN); Jianjun Chen, Guangdong (CN)

(73) Assignee: Guangzhou Baiyun Chemical Industry Co., Ltd., Guangdong (CN)

(21) Appl. No.: 17/413,343

(22) PCT Filed: Dec. 24, 2019
(86) PCT No.: PCT/CN2019/127969

§ 371 Date: Jun. 11, 2021

(30) Foreign Application Priority Data
Jun. 27, 2019 (CN) 201910570193.7

(51) Int. Cl. C08L 71/02; C08L 75/04; B01F 23/57; B01F 23/53; B01F 23/80; B01F 23/50; B01F 27/42; B01F 33/81; B01F 35/92

(52) U.S. Cl. CPC C08L 71/02; C08L 75/04; B01F 23/57; B01F 23/53; B01F 23/802; B01F 2035/98; B01F 27/421; B01F 33/811; B01F 35/92; C08L 2205/025; C08L 2205/035; B01F 23/511

(57) ABSTRACT

A continuous production device and method for a silane-modified sealing material are provided. The device includes a twin screw extruder set, a cooling unit, and a static mixing unit; where the twin screw extruder set includes at least two twin screw extruders in series, each of which is provided with at least two inlets and at least one vacuum port, the cooling unit is disposed between last two stages of the twin screw extruders, and an outlet of a last-stage twin screw extruder is connected to the static mixing unit. Through the arrangement of various units of the device and their positional relations, components can be mixed in sequence or added in stages, so as to adapt to the characteristics of each component; a heat stabilizer and a polymer are added together as raw materials, which can increase the temperature for dehydration and avoid thermal decomposition of the polymer, and they cooperate with a dehydrant to make water in the system easier to remove; and the device has high operation flexibility and can adapt to the requirement of variability of a formulation of the silane-modified sealing material.

### TECHNICAL FIELD

The present application belongs to the field of sealing material production and relates to a continuous production device and method for a silane-modified sealing material.

### BACKGROUND

As a common material in production and life, sealing materials may be classified into different categories based on composition. At present, the sealing materials on the market mainly include polyether sealing materials, polyurethane sealing materials, and silicone sealing materials. As a new generation of sealing materials, silane-modified sealing materials are mainly prepared from silane-terminated polyether or silane-terminated polyurethane as a base polymer and widely applied to the fields of construction, home decoration, automobiles, ships, and electronic devices, etc. due to the advantages of environmental friendliness and excellent cohesiveness and aging resistance. Moreover, due to flexible and variable formulation combinations during preparation, the silane-modified sealing materials can be applied to both the filler sealing of displacement joints and the cohesion of high-strength structures, thus having an increasing market share.

At present, most silane-modified sealing materials are produced by using a batch planetary mixer or reaction kettle with low production efficiency, large energy consumption, and more lot-to-lot quality fluctuation. Moreover, silane-modified polymers have high hydrophilicity, and the sealing materials manufactured therefrom are pretty sensitive to water vapor. Therefore, water in a system needs to be removed during production, which makes it difficult to achieve the continuous production of the silane-modified sealing materials. To this end, water removal in the production process needs to be resolved.

A conventional continuous production process for sealants generally adopts a method of instantaneous heating vacuum dehydration, which is not applicable to the production of silane-modified sealants mainly because the silane-modified polymers have poor resistance to heat. The silane-modified polymers will decompose at a temperature higher than 110° C. Water cannot be completely removed at a relatively low temperature, which affects the storage stability of the silane-modified sealants. CN102827568A has disclosed a continuous and automatic production process for a single-component silane-modified polyether sealant. The silane-modified polyether sealant is produced by the methods of base material production, static mixing automatic sealant preparation, and dispensing. However, since a heating vacuum dehydration method is adopted during the base material production and the silane-modified polymers have poor resistance to heat, the selection of the temperature may cause silane-modified polyether compounds to decompose, thereby affecting product quality. In addition, due to low continuity and little room to adjust for the production process, the production process cannot adapt to the variability of the formulation of materials.

To conclude, the production process of the silane-modified sealing materials still needs to be improved, so as to achieve sufficient water removal in the continuous production process without affecting the product quality while increasing room to adjust the production process.

### SUMMARY

The following is a summary of the subject matter described herein in detail. This summary is not intended to limit the scope of the claims.

An object of the present application is to provide a continuous production device and method for a silane-modified sealing material. By using multiple-stage twin screw extruders, components are added in stages during the production of the sealing material, while a heat stabilizer is added to improve the thermal stability of a polymer, thereby ensuring the removal of water. The device has high operation flexibility and can achieve the continuous production of the sealing material with stable product quality.

To achieve this object, the present application adopts technical solutions described below.

In one aspect, the present application provides a continuous production device for a silane-modified sealing material. The device includes a twin screw extruder set, a cooling unit, and a static mixing unit.

The twin screw extruder set includes at least two twin screw extruders in series, each of which is provided with at least two inlets and at least one vacuum port, the cooling unit is disposed between last two stages of the twin screw extruders, and an outlet of a last-stage twin screw extruder is connected to the static mixing unit.

In the present application, when the device is adopted to produce the silane-modified sealing material, with the arrangement of the twin screw extruder set and of the cooling unit between twin screw extruders, components may be mixed in sequence or added in stages so as to adapt to the characteristics of each component and sufficiently remove water in the production process of the sealing material. The device has high operation flexibility and is adaptable to the requirement of the variability of the formulation of the silane-modified sealing material, with greatly improved production efficiency and stable product quality.

The following are optional solutions of the present application and not to be construed as limitations to the solutions provided by the present application. Through the following solutions, the objects and the beneficial effects of the present application can be better achieved and implemented.

As an optional solution of the present application, the device further includes a pre-mixing unit, where an outlet of the pre-mixing unit is connected to an inlet of a first-stage twin screw extruder.

Optionally, the pre-mixing unit includes two pre-mixing vessels that are arranged in parallel.

Optionally, each of the two pre-mixing vessels is provided with a stirring means inside.

Optionally, a connection pipe between each of the two pre-mixing vessels and the first-stage twin screw extruder is independently provided with a valve.

In the present application, the pre-mixing unit is provided with a pair of parallel pre-mixing vessels for raw materials, and the two pre-mixing vessels may be used alternately to achieve the continuous operation of the device. Meanwhile, components in a formulation may be flexibly distributed to different pre-mixing vessels to satisfy the selection of multiple polymers as raw materials and adapt to the variability of the formulation of the silane-modified sealing material.

As an optional solution of the present application, the twin screw extruder set includes two twin screw extruders in series, and the cooling unit is disposed between a first-stage twin screw extruder and a second-stage twin screw extruder.

Optionally, each of the two twin screw extruders is provided with a jacket outside.

In the present application, the number of the twin screw extruders is selected according to the requirement and effect of dehydration in the production process of the sealing material. Two twin screw extruders in series are preferred, with the first-stage twin screw extruder using heating vacuum dehydration, and the second-stage twin screw extruder using vacuum dehydration, both of which are added with a dehydrant. Each twin screw extruder is specified for temperature and thus provided with the jacket for heating or cooling.

In another aspect, the present application provides a method for continuously producing a silane-modified sealing material by using the device described above. The method includes the following steps:

(1) mixing a silane-modified polymer and a heat stabilizer as raw materials, and adding the mixed raw materials to a first-stage twin screw extruder;

(2) adding a filler, a plasticizer, a thixotropic agent, a light stabilizer, and a dehydrant to the first-stage twin screw extruder, and performing a treatment in a twin screw extruder upstream of a cooling unit under heating and vacuum; and

(3) cooling a discharge in step (2) before entering a last-stage twin screw extruder, adding a dehydrant, a coupling agent, and a catalyst, and performing a treatment under a vacuum condition and then static mixing to obtain the silane-modified sealing material.

In the present application, in the production process of the silane-modified sealing material, the heat stabilizer and the silane-modified polymer are added together as the raw materials so that the thermal stability of the polymer can be improved and the temperature for dehydration can be increased, thereby avoiding thermal decomposition of the polymer affecting the product quality. Meanwhile, the dehydrant, as one of the components, functions together with heating vacuum dehydration, making water in the production system easier to remove, thereby facilitating continuous production.

As an optional solution of the present application, the silane-modified polymer in step (1) includes silane-terminated polyether and/or silane-terminated polyurethane.

In the present application, the silane-terminated polyether and/or the silane-terminated polyurethane have the following structural formula:

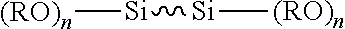

where R is —CH₃ or —C₂H₅, and n is 2 or 3.

The silane-modified polymer mainly includes MS resin from KANEKA, STP-E resin from WACKER, and SPUR resin from MOMENTIVE, etc. Optionally, a silane-terminated end group includes any one of trimethoxysilyl, methyldimethoxysilyl, triethoxysilyl, or ethyldiethoxysilyl.

Optionally, the heat stabilizer includes a phosphite antioxidant and/or a hindered phenol antioxidant.

In the present application, commonly used heat stabilizers include IRGANOX 1010, IRGANOX 168, IRGANOX 126, IRGANOX 245, and IRGANOX 1135, etc. from BASE

Optionally, the raw materials in step (1) further include a filler and/or a plasticizer.

Optionally, the filler is a powder filler and includes any one or a combination of at least two of ground calcium carbonate (GCC), nano precipitated calcium carbonate (NPCC), fumed silica, or silicon micro powder. Typical but non-limiting examples of the combination include a combination of GCC and NPCC, a combination of NPCC and fumed silica, and a combination of GCC, fumed silica, and silicon micro powder, etc.

Optionally, the plasticizer includes a phthalate and/or a polyether polyol.

Optionally, the mixing in step (1) is performed in a pre-mixing unit.

Optionally, two pre-mixing vessels of the pre-mixing unit are used alternately.

Optionally, the mixed raw materials are added from a same inlet or different inlets of the first-stage twin screw extruder.

As an optional solution of the present application, the filler in step (2) is a powder filler and includes any one or a combination of at least two of GCC, NPCC, fumed silica, or silicon micro powder. Typical but non-limiting examples of the combination include a combination of GCC and NPCC, a combination of NPCC and fumed silica, and a combination of GCC, fumed silica, and silicon micro powder, etc.

Optionally, the plasticizer in step (2) includes a phthalate and/or a polyether polyol.

Optionally, the thixotropic agent in step (2) includes polyamide wax and/or fumed silica.

Optionally, the light stabilizer in step (2) includes an ultraviolet absorber and/or a radical trap.

Optionally, the ultraviolet absorber includes any one or a combination of at least two of salicylates, benzophenones, benzotriazoles, substituted acrylonitriles, or triazines. Typical but non-limiting examples of the combination include a combination of salicylates and the benzophenones, a combination of benzophenones and benzotriazoles, and a combination of benzotriazoles, substituted acrylonitriles, and triazines, etc.

Optionally, the radical trap includes hindered amine.

In the present application, commonly used ultraviolet absorbers include UV-P, UV-9, UV-531, and UV-326, and hindered amine light stabilizers include light stabilizer 622, light stabilizer 770, and light stabilizer 944, etc.

Optionally, the dehydrant in step (2) includes 3-isocyanatopropyltrimethoxysilane and/or vinyltrimethoxysilane.

Optionally, the dehydrant in step (2) is added in batches during the treatment.

In the present application, the addition of the dehydrant in batches helps giving full play to the effect of the dehydrant in a dehydration process, which cooperates with the heating vacuum dehydration to ensure that water removal meets the requirement.

As an optional solution of the present application, the twin screw extruder set comprises two stages, and the treatment in step (2) is merely performed in the first-stage twin screw extruder.

Optionally, the treatment in step (2) is performed at a temperature of 110° C. to 140° C., for example, 110° C., 115° C., 120° C., 125° C., 130° C., 135° C., or 140° C., etc. However, the temperature is not limited to the listed values, and other unlisted values within this value range are also applicable.

In the present application, the silane-modified polymer has poor resistance to heat and decomposes at a temperature higher than 110° C., and the addition of the heat stabilizer in the present application can make the temperature of dehydration higher than 110° C., increasing the temperature for dehydration and facilitating the improvement of production efficiency.

Optionally, the vacuum condition in step (2) is a vacuum degree of −0.08 MPa to −0.1 MPa, for example, −0.08 MPa, −0.085 MPa, −0.09 MPa, −0.095 MPa, or −0.1 MPa, etc. However, the vacuum degree is not limited to the listed values, and other unlisted values within this value range are also applicable.

Optionally, the treatment in step (2) is performed for 3 min to 10 min, for example, 3 min, 4 min, 5 min, 6 min, 7 min, 8 min, 9 min, or 10 min, etc. However, the time is not limited to the listed values, and other unlisted values within this value range are also applicable.

In the present application, the treatment time is generally determined by the rotational speed of a screw extruder, a combination of screw elements, and the consistency of the raw materials and specifically determined according to the selection of the device and the raw materials in an actual production process.

As an optional solution of the present application, in step (3), after cooling, the discharge has a temperature of 40° C. to 60° C., for example, 40° C., 45° C., 50° C., 55° C., or 60° C., etc. However, the temperature is not limited to the values listed above, and the other values unlisted in this value range are also applicable.

Optionally, the dehydrant in step (3) includes 3-isocyanatopropyltrimethoxysilane and/or vinyltrimethoxysilane.

Optionally, the coupling agent in step (3) includes any one or a combination of at least two of γ-aminopropyltriethoxysilane, N-aminoethyl-γ-aminopropyltrimethoxysilane, or N-aminoethyl-γ-aminopropyltriethoxysilane. Typical but non-limiting examples of the combination include a combination of γ-aminopropyltriethoxysilane and N-aminoethyl-γ-aminopropyltrimethoxysilane, a combination of N-aminoethyl-γ-aminopropyltrimethoxysilane and N-aminoethyl-γ-aminopropyltriethoxysilane, and a combination of γ-aminopropyltriethoxysilane, N-aminoethyl-γ-aminopropyltrimethoxysilane, and N-aminoethyl-γ-aminopropyltriethoxysilane, etc.

Optionally, the catalyst in step (3) is an organotin catalyst.

Optionally, the organotin catalyst includes dibutyltin diacetate and/or dibutyltin diacetylacetonate.

Optionally, the vacuum condition in step (3) is a vacuum degree of −0.08 MPa to −0.1 MPa, for example, −0.08 MPa, −0.085 MPa, −0.09 MPa, −0.095 MPa, or −0.1 MPa, etc. However, the vacuum degree is not limited to the listed values, and other unlisted values within this value range are also applicable.

Optionally, the treatment under the vacuum condition in step (3) is performed for 3 min to 10 min, for example, 3 min, 4 min, 5 min, 6 min, 7 min, 8 min, 9 min, or 10 min, etc. However, the time is not limited to the listed values, and other unlisted values within this value range are also applicable.

Optionally, the static mixing in step (3) is performed in a static mixing unit.

Optionally, the static mixing unit is added with a colorant.

In the present application, the static mixing is a common way of continuously adding the colorant, which is simple and reliable to operate.

Optionally, the static mixing in step (3) is followed by dispensing.

Optionally, the dispensing is performed in a dispensing unit.

In the present application, Part of the components of the silane-modified sealing material may be added separately in different steps or added in batches in a same step, which is adjusted according to the overall flow rate and the consistency of the materials. In case where the materials have a too large flow rate or are relatively dilute, the addition of the filler and plasticizer in stages facilitates the dispersion, dehydration and transportation of the components and can increase room to adjust for the process, while the addition of the dehydrant in batches can ensure sufficient water removal during continuous production.

As an optional solution of the present application, the method includes the following steps:

(1) mixing a silane-modified polymer, a heat stabilizer, and a filler and/or a plasticizer, and adding the mixed raw materials to a first-stage twin screw extruder from a same inlet or different inlets of the first-stage twin screw extruder;

(2) then adding a filler, a plasticizer, a thixotropic agent, a light stabilizer, and a dehydrant to the first-stage twin screw extruder, where the dehydrant is added in batches; and performing a treatment in a twin screw extruder upstream of a cooling unit for 3 min to 10 min at a temperature of 110° C. to 140° C. and a vacuum degree of −0.08 MPa to −0.1 MPa; and

(3) cooling a discharge in step (2) to a temperature of 40° C. to 60° C. before entering a last-stage twin screw extruder, and then adding a dehydrant, a coupling agent, and a catalyst, and performing a treatment for 3 min to 10 min at a vacuum degree of −0.08 MPa to −0.1 MPa, followed by static mixing and dispensing in sequence to obtain the silane-modified sealing material, where a colorant is added during the static mixing.

Compared with the existing technologies, the present application has the following beneficial effects:

(1) through the arrangement of various units of the device in the present application and their positional relations, components can be mixed in sequence or added in stages, so as to adapt to the characteristics of each component and facilitate water removal in the production process of the sealing material;

(2) the heat stabilizer and the polymer are added together as raw materials, which can increase the temperature for dehydration and avoid thermal decomposition of the polymer affecting the product quality, and they cooperate with the dehydrant to make water in the system easier to remove; and

(3) the device of the present application has large operation flexibility and is adaptable to the requirement of the variability of the formulation of the silane-modified sealing material, with greatly improved production efficiency, reduced energy consumption, and stable product quality.

Other aspects can be understood after the detailed description and the drawings are read and understood.

### BRIEF DESCRIPTION OF DRAWINGS

FIG. 1 is a structural diagram of a continuous production device for a silane-modified sealing material according to Example 1 of the present application.

### REFERENCE LIST

1 first pre-mixing vessel
2 second pre-mixing vessel
3 first-stage twin screw extruder
4 cooling unit
5 second-stage twin screw extruder
6 static mixing unit
7 dispensing unit

### DETAILED DESCRIPTION

To better illustrate the present application and to facilitate the understanding of the solutions of the present application, the present application is further described in detail below. The examples described below are merely simplified examples of the present application and not intended to represent or limit the scope of the present application. The scope of the present application is defined by the claims.

The detailed description section of the present application provides a continuous production device and method for a silane-modified sealing material. The device includes a twin screw extruder set, a cooling unit 4, and a static mixing unit 6.

The twin screw extruder set includes at least two twin screw extruders in series, each of which is provided with at least two inlets and at least one vacuum port, the cooling unit 4 is disposed between last two stages of the twin screw extruders, and an outlet of a last-stage twin screw extruder is connected to the static mixing unit 6.

Typical but non-limiting examples of the present application are described below.

### Example 1

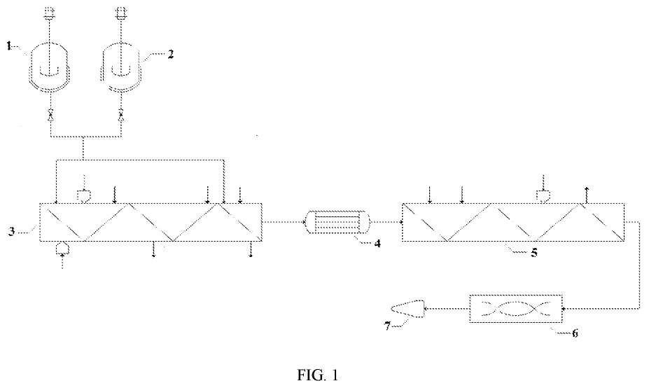

This example provides a continuous production device for a silane-modified sealing material. A structural diagram of the continuous production device is as shown in FIG. 1, and the device includes a twin screw extruder set, a cooling unit 4, and a static mixing unit 6.

The twin screw extruder set includes two twin screw extruders in series, the cooling unit 4 is disposed between a first-stage twin screw extruder 3 and a second-stage twin screw extruder 5, and an outlet of the second-stage twin screw extruder 5 is connected to the static mixing unit 6.

The device further includes a pre-mixing unit, where an outlet of the pre-mixing unit is connected to an inlet of the first-stage twin screw extruder 3, and the pre-mixing unit includes two pre-mixing vessels arranged in parallel including a first pre-mixing vessel 1 and a second pre-mixing vessel 2. Each pre-mixing vessel is provided with a stirring means inside. A connection pipe between each of the first pre-mixing vessel 1 and the second pre-mixing vessel 2 and the first-stage twin screw extruder 3 is independently provided with a valve.

The first-stage twin screw extruder 3 is provided with seven inlets and two vacuum ports, with two of the inlets connected to the pre-mixing unit. The second-stage twin screw extruder 5 is provided with four inlets and one vacuum port, with one of the inlets connected to the cooling unit 4.

The device further includes a dispensing unit 7, where an inlet of the dispensing unit 7 is connected to an outlet of the static mixing unit 6.

### Example 2

This example provides a continuous production device for a silane-modified sealing material. The continuous production device includes a twin screw extruder set, a cooling unit 4, and a static mixing unit 6.

The twin screw extruder set includes three twin screw extruders in series, the cooling unit 4 is disposed between a second-stage twin screw extruder and a third-stage twin screw extruder, and an outlet of the third-stage twin screw extruder is connected to the static mixing unit 6.

The device further includes a pre-mixing unit, where an outlet of the pre-mixing unit is connected to an inlet of a first-stage twin screw extruder 3, and the pre-mixing unit includes two pre-mixing vessels arranged in parallel including a first pre-mixing vessel 1 and a second pre-mixing vessel 2. Each pre-mixing vessel is provided with a stirring means inside. A connection pipe between each of the first pre-mixing vessel 1 and the second pre-mixing vessel 2 and the first twin-stage screw extruder 3 is independently provided with a valve.

The first-stage twin screw extruder 3 is provided with seven inlets and two vacuum ports, with two of the inlets connected to the pre-mixing unit. The third-stage twin screw extruder is provided with four inlets and one vacuum port, with one of the inlets connected to the cooling unit 4.

The device further includes a dispensing unit 7, where an inlet of the dispensing unit 7 is connected to an outlet of the static mixing unit 6.

In Examples 1 and 2, since the pre-mixing unit includes the two pre-mixing vessels, with one for supplying raw materials, while the other for mixing the raw materials, the two pre-mixing vessels can be used alternately to ensure the continuous supply of materials; and through the arrangement of the pre-mixing unit, the twin screw extruder set, and the cooling unit between twin screw extruders, components can be mixed in sequence or added in stages so as to adapt to the characteristics of each component and sufficiently remove water in the production process of the sealing material.

### Example 3

This example provides a continuous production method for a silane-modified sealing material. The silane-modified sealing material includes the following components in parts by weight: 50 parts of MS polymer S203H and 50 parts of MS polymer 5303H; 2 parts of IRGANOX 245 as a heat stabilizer; 60 parts of PPG3000 as a plasticizer; 100 parts of NPCC and 50 parts of GCC as fillers; 2 parts of polyamide wax as a thixotropic agent; 3 parts of vinyltrimethoxysilane as a dehydrant; 1 part of UV-9 and 1 part of UV-326 as light stabilizers; 2 parts of N-aminoethyl-γ-aminopropyltrimethoxysilane as a coupling agent; and 2 parts of dibutyltin diacetylacetonate as a catalyst.

The method was performed by using the device in Example 1 and included steps described below.

(1) 50 parts of MS polymer 5203H, 50 parts of MS polymer 5303H, and 2 parts of IRGANOX 245 were mixed in the pre-mixing vessel and added to the first-stage twin screw extruder 3, where the mixed raw materials were added from a single inlet of the first-stage twin screw extruder 3.

(2) NPCC and GCC in the above formulation were added according to their weight parts from one inlet of the first-stage twin screw extruder 3, the polyamide wax, UV-9, and UV-326 were added from another inlet of the first-stage twin screw extruder 3, PPG3000 was added from another inlet of the first-stage twin screw extruder 3, and 2 parts of vinyltrimethoxysilane were added in batches from two inlets of the first-stage twin screw extruder 3, and these components were heated to a temperature of 115° C. and treated for 10 min with a vacuum degree maintained at −0.09 MPa within the first-stage twin screw extruder 3.

(3) The discharge in step (2) was cooled to 50° C. and then fed into the second-stage twin screw extruder 5, the remaining vinyltrimethoxysilane, N-aminoethyl-γ-aminopropyltrimethoxysilane, and dibutyltin diacetylacetonate in the formulation were added from different inlets of the second-stage twin screw extruder 5, respectively, and these components were treated for 8 min with a vacuum degree maintained at −0.09 MPa, static mixed, and dispensed, so that the silane-modified sealing material was obtained, where a colorant was added during static mixing.

### Example 4

This example provides a continuous production method for a silane-modified sealing material.

The silane-modified sealing material includes the following components in parts by weight: 100 parts of STP-E polymer; 2 parts of IRGANOX 1010 as a heat stabilizer; 70 parts of diisodecyl phthalate as a plasticizer; 150 parts of NPCC and 10 parts of GCC as fillers; 2 parts of fumed silica as a thixotropic agent; 4 parts of 3-isocyanatopropyltrimethoxysilane as a dehydrant; 2 parts of light stabilizer 770 and 1 part of UV-327; 1 part of γ-aminopropyltriethoxysilane and 2 parts of N-aminoethyl-γ-aminopropyltriethoxysilane as coupling agents; and 3 parts of dibutyltin diacetate as a catalyst.

The method was performed by using the device in Example 1 and included steps described below.

(1) 100 parts of STP-E polymer, 2 parts of IRGANOX 245, and 10 parts of GCC were mixed in the pre-mixing vessel and added to the first-stage twin screw extruder 3, where the mixed raw materials were added from two inlets of the first-stage twin screw extruder 3.

(2) NPCC in the above formulation was added according to its weight parts from one inlet of the first-stage twin screw extruder 3, fumed silica, UV-327, and light stabilizer 770 were added from another inlet of the first-stage twin screw extruder 3, 50 parts of diisodecyl phthalate were added from yet another inlet of the first-stage twin screw extruder 3, and 3 parts of vinyltrimethoxysilane were added in batches from two inlets of the first-stage twin screw extruder 3, and these components were heated to a temperature of 130° C. and treated for 6 min with a vacuum degree maintained at −0.1 MPa within the first-stage twin screw extruder 3.

(3) The discharge in step (2) was cooled to 40° C. and then fed into the second-stage twin screw extruder 5, the remaining diisodecyl phthalate and 3-isocyanatopropyltrimethoxysilane in the formulation were added from different inlets of the second-stage twin screw extruder 5, respectively, γ-aminopropyltriethoxysilane, N-aminoethyl-γ-aminopropyltriethoxysilane, and dibutyltin diacetate were added from a same inlet, and these components were treated for 6 min with a vacuum degree maintained at −0.1 MPa, static mixed, and dispensed, so that the silane-modified sealing material was obtained, where a colorant was added during static mixing.

### Example 5

This example provides a continuous production method for a silane-modified sealing material. The silane-modified sealing material includes the following components in parts by weight: 40 parts of STP-E polymer and 60 parts of SPUR polymer; 2 parts of IRGANOX 126 as a heat stabilizer; 40 parts of PPG2000 as a plasticizer; 100 parts of NPCC and 60 parts of silicon micro powder as fillers; 10 parts of fumed silica; 3 parts of vinyltrimethoxysilane as a dehydrant; 2 parts of light stabilizer 622 and 2 parts of UV-P; 3 parts of γ-aminopropyltriethoxysilane as a coupling agent; and 1 part of dibutyltin diacetate and 1 part of dibutyltin diacetylacetonate as catalysts.

The method was performed by using the device in Example 2 and included steps described below.

(1) 40 parts of STP-E polymer, 60 parts of SPUR polymer, 2 parts of IRGANOX 126, 10 parts of PPG2000, and 10 parts of fumed silica were mixed in the pre-mixing vessel and added to the first-stage twin screw extruder 3, where the mixed raw materials were added from one inlet of the first-stage twin screw extruder 3.

(2) NPCC and silicon micro powder in the above formulation were added according to their weight parts from one inlet of the first-stage twin screw extruder 3, UV-P and light stabilizer 622 were added from another inlet of the first-stage twin screw extruder 3, 30 parts of PPG2000 were added from yet another inlet of the first-stage twin screw extruder 3, and 2 parts of vinyltrimethoxysilane were added in batches from two inlets of the first-stage twin screw extruder 3, and these components were heated to a temperature of 140° C. and treated for 3 min with a vacuum degree maintained at −0.08 MPa within the first-stage twin screw extruder 3. Then, these components were fed into the next twin screw extruder and treated for 2 min at the same temperature and pressure.

(3) The discharge in step (2) was cooled to 60° C. and then fed into the third-stage twin screw extruder, the remaining vinyltrimethoxysilane in the formulation was added from one inlet of the second-stage twin screw extruder 5, γ-aminopropyltriethoxysilane, dibutyltin diacetylacetonate, and dibutyltin diacetate were added from a same inlet, and these components were treated for 3 min with a vacuum degree maintained at −0.08 MPa, static mixed, and dispensed, so that the silane-modified sealing material was obtained, where a colorant was added during static mixing.

### Comparative Example 1

This comparative example provides a continuous production method for a silane-modified sealing material. The composition of the silane-modified sealing material is similar to that of Example 3 except that a heat stabilizer IRGANOX 245 is not included.

The method is similar to that of Example 3 except that the mixed raw materials in step (1) did not include the heat stabilizer IRGANOX 245.

The performance of the silane-modified sealing materials produced in Examples 3 to 5 and Comparative Example 1 was tested, where the surface tack free time, hardness, tensile strength, and elongation at break of the silane-modified sealing materials were measured. Tack free time was measured according to GB/T13477.5, the hardness was measured according to GB/T531.1, and the tensile strength and the elongation at break were measured according to GB/T528. The results are shown in Table 1.

TABLE 1
Results of performance test for silane-modified sealing
materials in Examples 3 to 5 and Comparative Example 1

| | | | | Comparative |
|---|---|---|---|---|
| | Example 3 | Example 4 | Example 5 | Example 1 |
| Tack free time (min) | 60 | 45 | 15 | 120 |
| Hardness (Shore A) | 12 | 20 | 60 | 5 |
| Tensile strength (MPa) | 1.3 | 2.5 | 4.0 | 0.6 |
| Elongation at break | 600 | 500 | 300 | 200 |
| (%) | | | | |

As can be seen from Table 1, the device of the present application can be adopted to continuously produce the silane-modified sealing material, the resulting silane-modified sealing materials may have performances varying depending on the types of polymers used and are all excellent in essential performances, and meanwhile, various sealing materials have obvious advantages in certain aspects and thus have respective unique applicability and meet the requirements of various products. In Comparative Example 1, due to the absence of a heat stabilizer, the polymers partially decomposed during vacuum dehydration at the comparable temperature and had a decreased crosslinking density. In terms of performance, surface drying is significantly slowed, and the hardness, tensile strength, and elongation at break significantly decreased.

The applicant has stated that although the detailed device and method of the present application are described through the examples described above, the present application is not limited to the detailed device and method described above, which means that the implementation of the present application does not necessarily depend on the detailed device and method described above.

1. A continuous production device for a silane-modified sealing material, comprising:
a twin screw extruder set, a cooling unit, and a static mixing unit;
wherein the twin screw extruder set comprises at least two twin screw extruders in series, each of which is provided with at least two inlets and at least one vacuum port, the cooling unit is disposed between last two stages of the twin screw extruders, and an outlet of a last-stage twin screw extruder is connected to the static mixing unit.

2. The continuous production device of claim 1, further comprising a pre-mixing unit, wherein an outlet of the pre-mixing unit is connected to an inlet of a first-stage twin screw extruder.

3. The continuous production device of claim 1, wherein the twin screw extruder set comprises two twin screw extruders in series, and the cooling unit is disposed between a first-stage twin screw extruder and a second-stage twin screw extruder.

4. A method for continuously producing a silane-modified sealing material by using the device of claim 1, comprising:
(1) mixing a silane-modified polymer and a heat stabilizer as raw materials, and adding the mixed raw materials to a first-stage twin screw extruder;
(2) adding a filler, a plasticizer, a thixotropic agent, a light stabilizer, and a dehydrant to the first-stage twin screw extruder, and performing a treatment in a twin screw extruder upstream of a cooling unit under heating and vacuum; and
(3) cooling a discharge in step (2) before entering a last-stage twin screw extruder, adding a dehydrant, a coupling agent, and a catalyst, and performing a treatment under a vacuum condition and then static mixing to obtain the silane-modified sealing material.

5. The method of claim 4, wherein the silane-modified polymer in step (1) comprises silane-terminated polyether and/or silane-terminated polyurethane.

6. The method of claim 4, wherein the heat stabilizer comprises a phosphite antioxidant and/or a hindered phenol antioxidant.

7. The method of claim 4, wherein the raw materials in step (1) further comprise a filler and/or a plasticizer.

8. The method of claim 4, wherein the mixing in step (1) is performed in a pre-mixing unit.

9. The method of claim 4, wherein the filler in step (2) is a powder filler and comprises any one or a combination of at least two of ground calcium carbonate, nano precipitated calcium carbonate, fumed silica, or silicon micro powder.

10. The method of claim 4, wherein the twin screw extruder set comprises two stages, and the treatment in step (2) is merely performed in the first-stage twin screw extruder.

11. The method of claim 4, wherein in step (3), after cooling, the discharge has a temperature of 40° C. to 60° C.

12. The method of claim 4, wherein the vacuum condition in step (3) is a vacuum degree of −0.08 MPa to −0.1 MPa.

13. The method of claim 4, comprising:
(1) mixing a silane-modified polymer, a heat stabilizer, and a filler and/or a plasticizer, and adding the mixed raw materials to a first-stage twin screw extruder from a same inlet or different inlets of the first-stage twin screw extruder;
(2) then adding a filler, a plasticizer, a thixotropic agent, a light stabilizer, and a dehydrant to the first twin screw extruder, wherein the dehydrant is added in batches; and performing a treatment in a twin screw extruder upstream of a cooling unit for 3 min to 10 min at a temperature of 110° C. to 140° C. and a vacuum degree of −0.08 MPa to −0.1 MPa; and
(3) cooling a discharge in step (2) to a temperature of 40° C. to 60° C. before entering a last-stage twin screw extruder, adding a dehydrant, a coupling agent, and a catalyst, and performing a treatment for 3 min to 10 min at a vacuum degree of −0.08 MPa to −0.1 MPa, followed by static mixing and dispensing in sequence to obtain the silane-modified sealing material, wherein a colorant is added during the static mixing.

14. The continuous production device of claim 1, wherein the device further comprises a dispensing unit with an inlet connected to an outlet of the static mixing unit.

15. The method of claim 5, wherein a silane-terminated end group comprises any one of trimethoxysilyl, methyldimethoxysilyl, triethoxysilyl, or ethyldiethoxysilyl.

16. The method of claim 8, wherein two pre-mixing vessels of the pre-mixing unit are used alternately.

17. The method of claim 4, wherein the mixed raw materials are added from a same inlet or different inlets of the first-stage twin screw extruder.

18. The method of claim 4, wherein the dehydrant in step (2) is added in batches during the treatment.

19. The method of claim 4, where the treatment in step (2) is performed at a temperature of 110° C. to 140° C.

20. The method of claim 4, wherein the vacuum condition in step (2) is a vacuum degree of −0.08 MPa to −0.1 MPa.
